(19) United States
(12) Patent Application Publication
(10) Pub. No.: US 2023/0041437 A1
(43) Pub. Date: Feb. 9, 2023

(54) SYSTEM FOR END-TO-END ELECTRONIC DATA ENCRYPTION USING AN INTELLIGENT HOMOMORPHIC ENCRYPED PRIVACY SCREEN

(71) Applicant: BANK OF AMERICA CORPORATION, Charlotte, NC (US)

(72) Inventors: Brandon Sloane, Indian Land, SC (US); Matthew K. Bryant, Gastonia, NC (US)

(73) Assignee: BANK OF AMERICA CORPORATION, Charlotte, NC (US)

(21) Appl. No.: 17/393,825

(22) Filed: Aug. 4, 2021

(51) Int. Cl. G06F 21/62; G06T 19/00; G06F 21/60; H04L 9/00; G02B 27/01

(52) U.S. Cl. CPC G06F 21/6245; G06T 19/006; G06F 21/602; H04L 9/008; G02B 27/017; G02B 2027/0178

(57) ABSTRACT

A system is provided for end-to-end electronic data encryption using an intelligent homomorphic encrypted privacy screen. In particular, the system may be configured to use homomorphic encryption on sensitive data displayed on a screen of a computing device. An augmented reality (“AR”) device may be used (e.g., a user) with the privacy screen such that the sensitive data that appears on the screen may be selectively decrypted. In this way, an authorized user may be able to view and interact with the encrypted data whereas an unauthorized user may not.

### FIELD OF THE INVENTION

The present disclosure embraces a system for end-to-end electronic data encryption using an intelligent homomorphic encrypted privacy screen.

### BACKGROUND

There is a need for an effective way to protect data from being viewed or accessed by unauthorized entities.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

A system is provided for end-to-end electronic data encryption using an intelligent homomorphic encrypted privacy screen. In particular, the system may be configured to use homomorphic encryption on sensitive data displayed on a screen of a computing device. An augmented reality (“AR”) device may be used (e.g., a user) with the privacy screen such that the sensitive data that appears on the screen may be selectively decrypted. In this way, an authorized user may be able to view and interact with the encrypted data whereas an unauthorized user may not.

Accordingly, embodiments of the present disclosure provide a system for end-to-end electronic data encryption using an intelligent homomorphic encrypted privacy screen, the system comprising a memory device with computer-readable program code stored thereon; a communication device; and a processing device operatively coupled to the memory device and the communication device, wherein the processing device is configured to execute the computer-readable program code to encrypt, using a cryptographic algorithm, a set of sensitive data to generate encrypted data; display the encrypted data on an intelligent privacy screen; receive authentication data from an augmented reality device associated with the intelligent privacy screen; transmit a cryptographic key to the augmented reality device, wherein the cryptographic key is a decryption key associated with the encrypted data; and decrypt, through the augmented reality device, the encrypted data using the cryptographic key.

In some embodiments, the cryptographic algorithm is a homomorphic algorithm, wherein the computer-readable program code, when executed, further causes the processing device to receive, from a user associated with the augmented reality device, a request to execute one or more operations on the encrypted data; and execute the one or more operations on the encrypted data, the one or more operations comprising at least one of an addition, substitution, or deletion of at least a portion of the encrypted data

In some embodiments, the computer-readable program code, when executed, further causes the processing device to establish a secure handshake connection to the augmented reality device, wherein the cryptographic key is transmitted to the augmented reality device through the secure handshake connection.

In some embodiments, the intelligent privacy screen is associated with a predefined list of authorized devices, wherein the predefined list of authorized devices comprises the augmented reality device.

In some embodiments, the set of sensitive data is encrypted using a first encryption key associated with the cryptographic key.

In some embodiments, the computer-readable program code, when executed, further causes the processing device to encrypt a second set of sensitive data using a second encryption key, wherein the cryptographic key is incompatible with the second set of sensitive data.

In some embodiments, the augmented reality device is a pair of smart glasses or a headset.

Embodiments of the present disclosure also provide a computer program product for end-to-end electronic data encryption using an intelligent homomorphic encrypted privacy screen, the computer program product comprising at least one non-transitory computer readable medium having computer-readable program code portions embodied therein, the computer-readable program code portions comprising executable code portions for encrypting, using a cryptographic algorithm, a set of sensitive data to generate encrypted data; displaying the encrypted data on an intelligent privacy screen; receiving authentication data from an augmented reality device associated with the intelligent privacy screen; transmitting a cryptographic key to the augmented reality device, wherein the cryptographic key is a decryption key associated with the encrypted data; and decrypting, through the augmented reality device, the encrypted data using the cryptographic key.

In some embodiments, the cryptographic algorithm is a homomorphic algorithm, wherein the computer-readable program code portions further comprise executable code portions for receiving, from a user associated with the augmented reality device, a request to execute one or more operations on the encrypted data; and executing the one or more operations on the encrypted data, the one or more operations comprising at least one of an addition, substitution, or deletion of at least a portion of the encrypted data

In some embodiments, the computer-readable program code portions further comprise executable code portions for establishing a secure handshake connection to the augmented reality device, wherein the cryptographic key is transmitted to the augmented reality device through the secure handshake connection.

In some embodiments, the intelligent privacy screen is associated with a predefined list of authorized devices, wherein the predefined list of authorized devices comprises the augmented reality device.

In some embodiments, the set of sensitive data is encrypted using a first encryption key associated with the cryptographic key.

In some embodiments, the computer-readable program code portions further comprise executable code portions for encrypting a second set of sensitive data using a second encryption key, wherein the cryptographic key is incompatible with the second set of sensitive data.

Embodiments of the present disclosure also provide a computer-implemented method for end-to-end electronic data encryption using an intelligent homomorphic encrypted privacy screen, wherein the computer-implemented method comprises encrypting, using a cryptographic algorithm, a set of sensitive data to generate encrypted data; displaying the encrypted data on an intelligent privacy screen; receiving authentication data from an augmented reality device associated with the intelligent privacy screen; transmitting a cryptographic key to the augmented reality device, wherein the cryptographic key is a decryption key associated with the encrypted data; and decrypting, through the augmented reality device, the encrypted data using the cryptographic key.

In some embodiments, the cryptographic algorithm is a homomorphic algorithm, wherein the computer-implemented method further comprises receiving, from a user associated with the augmented reality device, a request to execute one or more operations on the encrypted data; and executing the one or more operations on the encrypted data, the one or more operations comprising at least one of an addition, substitution, or deletion of at least a portion of the encrypted data

In some embodiments, the computer-implemented method further comprises establishing a secure handshake connection to the augmented reality device, wherein the cryptographic key is transmitted to the augmented reality device through the secure handshake connection.

In some embodiments, the intelligent privacy screen is associated with a predefined list of authorized devices, wherein the predefined list of authorized devices comprises the augmented reality device.

In some embodiments, the set of sensitive data is encrypted using a first encryption key associated with the cryptographic key.

In some embodiments, the computer-implemented method further comprises encrypting a second set of sensitive data using a second encryption key, wherein the cryptographic key is incompatible with the second set of sensitive data.

In some embodiments, the augmented reality device is a pair of smart glasses or a headset.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the encrypted privacy screen system, in accordance with one embodiment of the present disclosure; and

FIG. 2 illustrates a process flow for performing end-to-end electronic data encryption using an intelligent homomorphic encrypted privacy screen, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates an online system of networked computing devices, systems, and/or peripheral devices on which the system described herein is implemented. The entity may be a business organization, a non-profit organization, a government organization, and the like, which may routinely use various types of applications within its enterprise environment to accomplish its organizational objectives.

“Entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“Computing system” or “computing device” as used herein may refer to a networked computing device within the entity system. The computing system may include a processor, a non-transitory storage medium, a communications device, and a display. The computing system may be configured to support user logins and inputs from any combination of similar or disparate devices. Accordingly, the computing system may be a portable electronic device such as a smartphone, tablet, single board computer, smart device, or laptop. In other embodiments, the computing system may be a stationary unit such as a personal desktop computer, networked terminal, IoT device, or the like.

“User” as used herein may refer to an individual who may interact with the entity system to access the functions therein. Accordingly, the user may be an agent, employee, associate, contractor, or other authorized party who may access, use, administrate, maintain, and/or manage the computing systems within the entity system. In other embodiments, the user may be a client or customer of the entity.

Accordingly, the term “user device” or “mobile device” may refer to mobile phones, personal computing devices, tablet computers, wearable devices, and/or any stationary or portable electronic device capable of receiving and/or storing data therein.

“Cryptographic function” or “cryptographic algorithm” as used herein may refer to a set of logical and/or mathematical operations or processes that may be executed on a specified segment of data to produce a cryptographic output (or “cypher”). In some embodiments, the cryptographic algorithm may be an algorithm such as Rivest-Shamir-Adleman (“RSA”), Shamir's Secret Sharing (“SSS”), or the like. In other embodiments, the cryptographic algorithm may be a hash algorithm which may, given a specified data input, produce a cryptographic hash output value which is a fixed-length character string. Examples of such hash algorithms may include MD5, Secure Hash Algorithm/SHA, or the like. According, “hashing” or “hashed” as used herein may refer to the process of producing a hash output based on a data input into a hash algorithm.

In some embodiments, the cryptographic algorithm may be a homomorphic encryption algorithm that allows computing systems to perform logical and/or mathematical computations or operations on data encrypted using the homomorphic encryption algorithm. In such embodiments, the output of the computations performed on the encrypted data, when decrypted, may be the same as if such computations or operations had been performed on the decrypted data. “Homomorphic encryption” may also be referred to herein as “HE.”

“Key” or “cryptographic key” as used herein may refer to data (e.g., a character string) which determines the manner in which an input is transformed into an output using a cryptographic algorithm (e.g., an encryption algorithm). Accordingly, “symmetric cryptography” or “symmetric key cryptography” may refer to a process for data encryption by which multiple users and/or devices use the same key to encrypt communications.

In interacting with a computing device, a user may view various types of data that may be presented on a display of the computing device (e.g., a monitor or screen). In this regard, it may be desirable to protect sensitive data presented on the display from being accessed or viewed by unauthorized entities or individuals. Accordingly, the system described herein provides a way to safeguard sensitive data using an intelligent homomorphic encrypted privacy screen. The screen may be a display device that may be operatively coupled to the computing device (e.g., as a standalone unit or as a screen that may be placed over or in front of an existing display device) that may be configured to display data differently to authorized users as opposed to unauthorized users.

To this end, sensitive data stored and/or accessed on the computing device may be encrypted using a homomorphic encryption algorithm. The encrypted data may be presented on the privacy screen such that the data appears in encrypted form. In such a scenario, the encrypted data may not be viewed or read normally by an unauthorized user (e.g., an individual who may be able to see the screen by standing behind the authorized user). The authorized user may use a secondary device associated with the privacy screen and/or the computing device to decrypt the encrypted data. In this regard, the secondary device may be an augmented reality (“AR”) device (e.g., smart glasses, headset, or the like) that may be configured to decrypt the encrypted data that appears on the privacy screen. The AR device may comprise its own display device such that the privacy screen continues to display the encrypted data while the AR device decrypts and displays the decrypted data.

In this way, the authorized user (by using the AR device) may be able to view the decrypted data, while unauthorized users (e.g., users without the AR device) may not. Furthermore, because the data is encrypted using a homomorphic encryption algorithm, the authorized user may perform various operations on the encrypted data while visualizing the encrypted data as if it were decrypted by using the AR device. In other words, the system disclosed herein provides end-to-end encryption of sensitive data, as the decrypted data is not exposed to unauthorized parties, while maintaining usability and convenience. For instance, the sensitive data may include personally identifiable information (“PII”) such as a user's home address. In such scenarios, the authorized user may, through the AR device, view and edit the sensitive data (e.g., correcting a typo in the street name), while the sensitive data appears in an encrypted and thus unreadable form to any observers (e.g., unauthorized users) who may be reading the authorized user's screen.

An exemplary embodiment is provided below for illustrative purposes only and is not intended to restrict the scope of the disclosure. In one embodiment, an entity such as a financial institution may own and/or operate a number of computing devices in a network, where the computing devices may each comprise an intelligent homomorphic encrypted privacy screen. In this regard, the computing devices may be operated by a user such as an agent or employee of the entity, where the computing devices may be used to view and/or access sensitive data (e.g., a customer's PII). The user may use an AR device (e.g., a pair of smart glasses) when interacting with the computing device through the privacy screen. The sensitive data may be displayed on the privacy screen in encrypted form (e.g., using a homomorphic encryption algorithm), where the AR device may be configured to decrypt the encrypted data such that the sensitive data appears in decrypted form to the user. The AR device may be authenticated and/or authorized with the computing device and/or privacy screen (e.g., using a secure token or the like) such that the AR device is paired specifically with one or more privacy screens. In such an embodiment, individuals who are not equipped with the AR device specific to the privacy screen will only be able to see the sensitive data in encrypted form. Meanwhile, the authorized user (e.g., the user who is wearing the AR device) may interact with the encrypted data (e.g., editing, copying, deleting, viewing, or the like) as if it were decrypted. In this way, the system as described herein provides end-to-end encryption of sensitive data to authorized users.

The system as described herein confers a number of technological advantages over conventional data encryption systems. For instance, by pairing an AR device with an intelligent privacy screen, the system may selectively allow authorized users to view the decrypted data while maintaining an encrypted appearance to unauthorized users (e.g., viewers who may be able to see the privacy screen). Furthermore, by using homomorphic encryption, the system ensures that the sensitive data will remain encrypted until viewed by the authorized user via the AR device, which in turn reduces the chance of the decrypted data being intercepted by any unauthorized users.

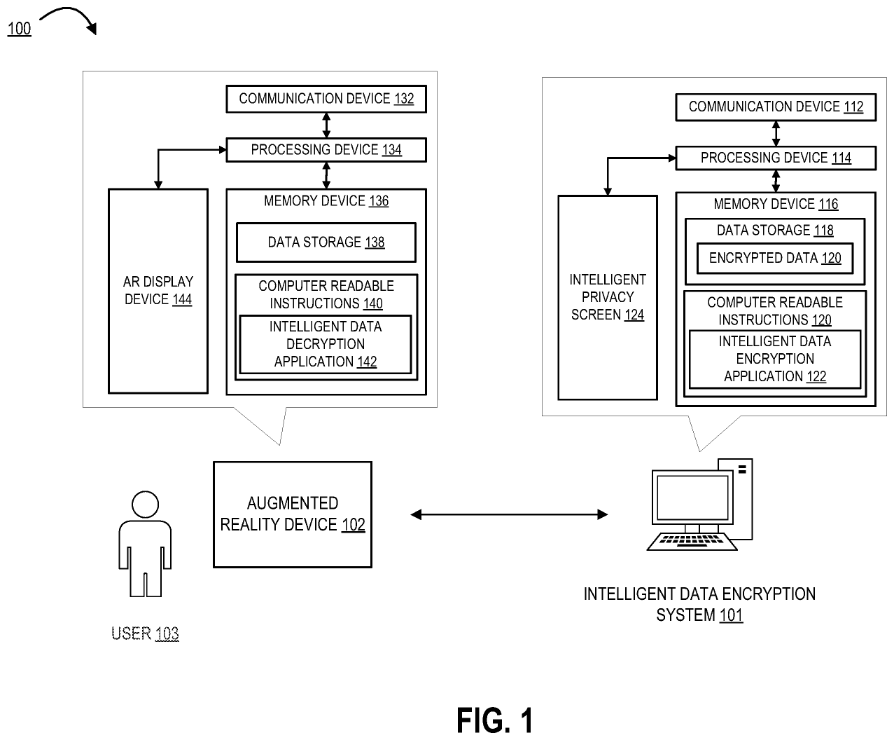

Turning now to the figures, FIG. 1 illustrates an operating environment 100 for the encrypted privacy screen system, in accordance with one embodiment of the present disclosure. In particular, FIG. 1 illustrates an intelligent data encryption system 101 that is operatively coupled, via a network, to an augmented reality device 102. In such a configuration, the intelligent data encryption system 101 may transmit information to and/or receive information from the augmented reality device 102.

It should be understood by one skilled in the art that FIG. 1 illustrates only an exemplary embodiment of the operating environment 100, and it will be appreciated that the operating environment 100 may comprise a fewer or greater number of computing systems and/or devices than are depicted in FIG. 1. It should also be understood that one or more functions of the systems, devices, or servers as depicted in FIG. 1 may be combined into a single system, device, or server. For instance, in some embodiments, at least a portion of the functions of the intelligent data encryption system 101 may be performed by the augmented reality device 102, or conversely, at least a portion of the functions of the augmented reality device 102 may be performed by the intelligent data encryption system 101. Furthermore, a single system, device, or server as depicted in FIG. 1 may represent multiple systems, devices, or servers.

The network may be a system specific distributive network receiving and distributing specific network feeds and identifying specific network associated triggers. The network may include one or more cellular radio towers, antennae, cell sites, base stations, telephone networks, cloud networks, radio access networks (RAN), Wi-Fi networks, or the like. Additionally, the network may also include a global area network (GAN), such as the Internet, a wide area network (WAN), a local area network (LAN), or any other type of network or combination of networks. Accordingly, the network may provide for wireline, wireless, or a combination wireline and wireless communication between devices on the network.

As illustrated in FIG. 1, the intelligent data encryption system 101 may be a computing system that may be operated by a user 103 to view, edit, and interact with sensitive data stored within the intelligent data encryption system 101 or elsewhere within the network environment. Accordingly, the intelligent data encryption system 101 may comprise a processing device 114 operatively coupled to a communication device 112 and a memory device 116 having data storage 118 and computer readable instructions 120 stored thereon.

As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 114 may use the communication device 112 to communicate with the network and other devices on the network, such as, but not limited to the augmented reality device 102. Accordingly, the communication device 112 generally comprises one or more hardware components such as a modem, antennae, Wi-Fi or Ethernet adapter, radio transceiver, or other device for communicating with other devices on the network.

The processing device 114 may further be operatively coupled to an intelligent privacy screen 124. The intelligent privacy screen 124 may be a display device configured to intelligently display encrypted data to non-authorized users while allowing such data to be decrypted by authorized users (e.g., when the intelligent privacy screen 124 is viewed by the user 103 through the augmented reality device 102). In this regard, the intelligent privacy screen 124 may be paired with the augmented reality device 102 to perform authorized and authenticated decryption of sensitive data.

In some embodiments, the memory device 116 includes data storage 118 for storing data related to the system environment. In this regard, the data storage 118 may comprise encrypted data 120, which may be sensitive data that has been encrypted. In some embodiments, the encrypted data 120 may be encrypted using a homomorphic encryption algorithm such that the encrypted data 120 may be manipulated (e.g., by the user 103) in an encrypted form.

The memory device 116 may further have computer-readable instructions 120 stored thereon, where the computer-readable instructions 120 may comprise a intelligent data encryption application 122, which may comprise computer-executable program code that may instruct the processing device 114 to perform certain logic, data processing, and data storing functions of the application to accomplish the entity's objectives. For instance, the intelligent data encryption application 122 may generate the encrypted data 120 by encrypting sensitive data using a homomorphic algorithm. The data encryption application 122 may further cause the encrypted data to appear on the intelligent privacy screen 124 in encrypted form such that it may be decrypted by the augmented reality device 102. In this regard, the intelligent data encryption application 122 may be configured to share a cryptographic key with the augmented reality device 102 to allow the encrypted data 120 to be decrypted.

As further illustrated in FIG. 1, the operating environment 100 may further comprise an augmented reality device 102 in operative communication with the intelligent data encryption system 101. In particular, the augmented reality device 102 may be a computing device with extended reality (e.g., virtual reality, augmented reality, mixed reality, or the like) capabilities, such as a headset, heads up display (“HUD”), smart glasses, smartphones, or the like that may be used by the user 103 to interact with the encrypted data 120.

The intelligent data encryption system 101 may comprise a processing device 134 operatively coupled to a communication device 132 and a memory device 136 having data storage 138 and computer readable instructions 140 stored thereon. The computer readable instructions 140 may comprise an intelligent data decryption application 142 that may be configured to decrypt the encrypted data 120 such that the decrypted data may be viewed or edited by the user 103. To this end, the intelligent data decryption application 142 may comprise a cryptographic key that may be used to decrypt the encrypted data 120. The processing device 134 may further be coupled to an AR display device 144, which may be a display that allows the user to view projected images on real-world objects. In this regard, the AR display device 144 may be a smart lens that may be configured to display the decrypted version of the encrypted data 120 when the user 103 views the intelligent privacy screen 124 of the intelligent data encryption system 101. For instance, the AR display device 144 may superimpose the decrypted data on top of the encrypted data 120 that is displayed on the intelligent privacy screen 124.

The communication devices as described herein may comprise a wireless local area network (WLAN) such as Wi-Fi based on the Institute of Electrical and Electronics Engineers' (IEEE) 802.11 standards, Bluetooth short-wavelength UHF radio waves in the ISM band from 2.4 to 2.485 GHz or other wireless access technology. Alternatively or in addition to the wireless interface, the computing systems may also include a communication interface device that may be connected by a hardwire connection to the resource distribution device. The interface device may comprise a connector such as a USB, SATA, PATA, SAS or other data connector for transmitting data to and from the respective computing system.

The computing systems described herein may each further include a processing device communicably coupled to devices as a memory device, output devices, input devices, a network interface, a power source, a clock or other timer, a camera, a positioning system device, a gyroscopic device, one or more chips, and the like. For instance, the computing systems may comprise a user interface comprising one or more input devices (e.g., a keyboard, keypad, microphone, mouse, tracking device, biometric readers, capacitive sensors, or the like) and/or output devices (e.g., a display such as a monitor, projector, headset, touchscreen, and/or auditory output devices such as speakers, headphones, or the like) for interacting with a user.

In some embodiments, the computing systems may access one or more databases or datastores (not shown) to search for and/or retrieve information related to the service provided by the entity. The computing systems may also access a memory and/or datastore local to the various computing systems within the operating environment 100.

The processing devices as described herein may include functionality to operate one or more software programs or applications, which may be stored in the memory device. For example, a processing device may be capable of operating a connectivity program, such as a web browser application. In this way, the computing systems may transmit and receive web content, such as, for example, product valuation, service agreements, location-based content, and/or other web page content, according to a Wireless Application Protocol (WAP), Hypertext Transfer Protocol (HTTP), and/or the like.

A processing device may also be capable of operating applications. The applications may be downloaded from a server and stored in the memory device of the computing systems. Alternatively, the applications may be pre-installed and stored in a memory in a chip.

The chip may include the necessary circuitry to provide integration within the devices depicted herein. Generally, the chip will include data storage which may include data associated with the service that the computing systems may be communicably associated therewith. The chip and/or data storage may be an integrated circuit, a microprocessor, a system-on-a-chip, a microcontroller, or the like. In this way, the chip may include data storage. Of note, it will be apparent to those skilled in the art that the chip functionality may be incorporated within other elements in the devices. For instance, the functionality of the chip may be incorporated within the memory device and/or the processing device. In a particular embodiment, the functionality of the chip is incorporated in an element within the devices. Still further, the chip functionality may be included in a removable storage device such as an SD card or the like.

A processing device may be configured to use the network interface to communicate with one or more other devices on a network. In this regard, the network interface may include an antenna operatively coupled to a transmitter and a receiver (together a “transceiver”). The processing device may be configured to provide signals to and receive signals from the transmitter and receiver, respectively. The signals may include signaling information in accordance with the air interface standard of the applicable cellular system of the wireless telephone network that may be part of the network. In this regard, the computing systems may be configured to operate with one or more air interface standards, communication protocols, modulation types, and access types. By way of illustration, the devices may be configured to operate in accordance with any of a number of first, second, third, fourth, and/or fifth-generation communication protocols and/or the like. For example, the computing systems may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, or the like. The devices may also be configured to operate in accordance with non-cellular communication mechanisms, such as via a wireless local area network (WLAN) or other communication/data networks.

The network interface may also include an application interface in order to allow a user or service provider to execute some or all of the above-described processes. The application interface may have access to the hardware, e.g., the transceiver, and software previously described with respect to the network interface. Furthermore, the application interface may have the ability to connect to and communicate with an external data storage on a separate system within the network.

The devices may have an interface that includes user output devices and/or input devices. The output devices may include a display (e.g., a liquid crystal display (LCD) or the like) and a speaker or other audio device, which are operatively coupled to the processing device. The input devices, which may allow the devices to receive data from a user, may include any of a number of devices allowing the devices to receive data from a user, such as a keypad, keyboard, touch-screen, touchpad, microphone, mouse, joystick, other pointer device, button, soft key, and/or other input device(s).

The devices may further include a power source. Generally, the power source is a device that supplies electrical energy to an electrical load. In some embodiment, power source may convert a form of energy such as solar energy, chemical energy, mechanical energy, or the like to electrical energy. Generally, the power source may be a battery, such as a lithium battery, a nickel-metal hydride battery, or the like, that is used for powering various circuits, e.g., the transceiver circuit, and other devices that are used to operate the devices. Alternatively, the power source may be a power adapter that can connect a power supply from a power outlet to the devices. In such embodiments, a power adapter may be classified as a power source “in” the devices.

As described above, the computing devices as shown in FIG. 1 may also include a memory device operatively coupled to the processing device. As used herein, “memory” may include any computer readable medium configured to store data, code, or other information. The memory device may include volatile memory, such as volatile Random-Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the devices described herein.

The computing systems may further comprise a gyroscopic device. The positioning system, input device, and the gyroscopic device may be used in correlation to identify phases within a service term.

Each computing system may also have a control system for controlling the physical operation of the device. The control system may comprise one or more sensors for detecting operating conditions of the various mechanical and electrical systems that comprise the computing systems or of the environment in which the computing systems are used. The sensors may communicate with the processing device to provide feedback to the operating systems of the device. The control system may also comprise metering devices for measuring performance characteristics of the computing systems. The control system may also comprise controllers such as programmable logic controllers (PLC), proportional integral derivative controllers (PID) or other machine controllers. The computing systems may also comprise various electrical, mechanical, hydraulic or other systems that perform various functions of the computing systems. These systems may comprise, for example, electrical circuits, motors, compressors, or any system that enables functioning of the computing systems.

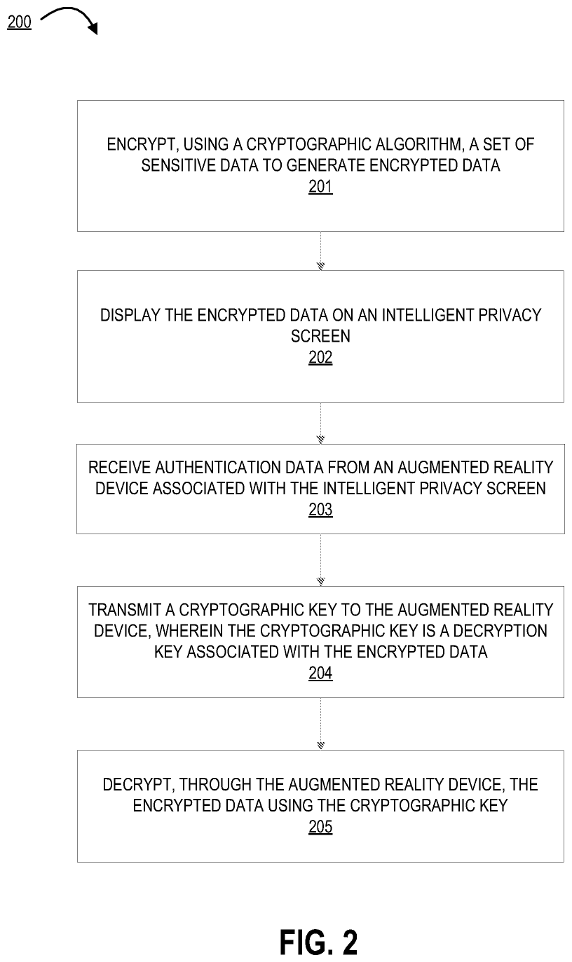

FIG. 2 illustrates a process flow 200 for performing end-to-end electronic data encryption using an intelligent homomorphic encrypted privacy screen, in accordance with some embodiments of the present disclosure. The process begins at block 201, where the system encrypts, using a cryptographic algorithm, a set of sensitive data to generate encrypted data. The sensitive data may include information that an entity has identified as requiring data protection, such as passcodes or authentication data, PII, classified internal documents, or the like.

The process continues to block 202, where the system displays the encrypted data on an intelligent privacy screen. The privacy screen may present the sensitive data in encrypted form such that the data remains encrypted to the unaided eye. In an exemplary embodiment, an authorized user (e.g., a user who has been authorized to view the sensitive data) may open a document or webpage containing the sensitive data (e.g., a customer's address). As the sensitive data remains in encrypted form, the sensitive data is protected from potential onlookers (e.g., unauthorized users) who may be in viewing range of the authorized user's privacy screen.

The process continues to block 203, where the system receives authentication data from an augmented reality device associated with the intelligent privacy screen. In this regard, the privacy screen may be associated with a predefined list of authorized devices, where the list may include an augmented reality device. The privacy screen may be configured to securely pair with the one or more devices within the predefined list of authorized devices. Accordingly, the system may require the AR device to provide authentication credentials associated with the user and/or the AR. The authentication credentials may include information such as a secure token, biometric information, or the like. Once the authentication credentials have been verified, the system may further be configured to initiate a secure handshake connection (e.g., a Transport Layer Security or “TLS” connection) with the AR device.

The process continues to block 204, where the system transmits a cryptographic key to the augmented reality device, wherein the cryptographic key is a decryption key associated with the encrypted data. The cryptographic key may be transferred to the AR device through the secure handshake connection, may be used by the AR device to decrypt the encrypted data that is displayed on the privacy screen. In some embodiments, the cryptographic key may specifically be associated with a particular authorized device (e.g., the AR device). In this way, the system may segment the sensitive data according to which users or devices are authorized to access the sensitive data. For instance, it may be desirable to authorize certain AR devices to view certain types of data while excluding the AR device from viewing others. To this end, the sensitive data that the AR device is authorized to view and edit may be encrypted using a first encryption key (which is associated with the cryptographic key sent to the AR device), whereas the sensitive data that the AR device is not authorized to view may be encrypted using a second encryption key (that is not associated with the cryptographic key sent to the AR device) such that the cryptographic key is not compatible with data that is encrypted using the second encryption key. In this way, the system may provide selective encryption/decryption functions to different devices.

The process continues to block 205, where the system decrypts, through the augmented reality device, the encrypted data using the cryptographic key. In this regard, the augmented reality device may decrypt the encrypted data and present decrypted data on a display device of the AR device. In particular, the decrypted data may be displayed using augmented reality functions such that the decrypted data is superimposed on and/or overlaps the encrypted data that is displayed on the privacy screen. In this way, the authorized user, who is using the AR device, may view the encrypted data on the privacy screen as if it were decrypted. To the remaining users within the authorized user's environment, the data remains in encrypted form, thereby allowing the system to provide selective access to sensitive data to authorized users.

In some embodiments, the cryptographic algorithm used to encrypt the sensitive data may be a homomorphic encryption algorithm. In such embodiments, the system may receive a request to perform one or more logical and/or mathematical operations on the encrypted data from the user and/or augmented reality device. Examples of such operations may include additions, deletions, substitutions, edits, copies, or the like of the encrypted data. Because the algorithm used is a homomorphic algorithm, the processes may be run on the encrypted data as if the operations were executed on decrypted data. Upon receiving the request, the system may execute the set of operations on the encrypted data. In this way, the system ensures that the data remains encrypted while the operations are being performed (the data is not decrypted in order to perform the operations).

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for end-to-end electronic data encryption using an intelligent homomorphic encrypted privacy screen, the system comprising:
a memory device with computer-readable program code stored thereon;
a communication device; and
a processing device operatively coupled to the memory device and the communication device, wherein the processing device is configured to execute the computer-readable program code to:
encrypt, using a cryptographic algorithm, a set of sensitive data to generate encrypted data;
display the encrypted data on an intelligent privacy screen;
receive authentication data from an augmented reality device associated with the intelligent privacy screen;
transmit a cryptographic key to the augmented reality device, wherein the cryptographic key is a decryption key associated with the encrypted data; and
decrypt, through the augmented reality device, the encrypted data using the cryptographic key.

2. The system according to claim 1, wherein the cryptographic algorithm is a homomorphic algorithm, wherein the computer-readable program code, when executed, further causes the processing device to:
receive, from a user associated with the augmented reality device, a request to execute one or more operations on the encrypted data; and
execute the one or more operations on the encrypted data, the one or more operations comprising at least one of an addition, substitution, or deletion of at least a portion of the encrypted data

3. The system according to claim 1, wherein the computer-readable program code, when executed, further causes the processing device to establish a secure handshake connection to the augmented reality device, wherein the cryptographic key is transmitted to the augmented reality device through the secure handshake connection.

4. The system according to claim 1, wherein the intelligent privacy screen is associated with a predefined list of authorized devices, wherein the predefined list of authorized devices comprises the augmented reality device.

5. The system according to claim 1, wherein the set of sensitive data is encrypted using a first encryption key associated with the cryptographic key.

6. The system according to claim 1, wherein the computer-readable program code, when executed, further causes the processing device to encrypt a second set of sensitive data using a second encryption key, wherein the cryptographic key is incompatible with the second set of sensitive data.

7. The system according to claim 1, wherein the augmented reality device is a pair of smart glasses or a headset.

8. A computer program product for end-to-end electronic data encryption using an intelligent homomorphic encrypted privacy screen, the computer program product comprising at least one non-transitory computer readable medium having computer-readable program code portions embodied therein, the computer-readable program code portions comprising executable code portions for:
encrypting, using a cryptographic algorithm, a set of sensitive data to generate encrypted data;
displaying the encrypted data on an intelligent privacy screen;
receiving authentication data from an augmented reality device associated with the intelligent privacy screen;
transmitting a cryptographic key to the augmented reality device, wherein the cryptographic key is a decryption key associated with the encrypted data; and
decrypting, through the augmented reality device, the encrypted data using the cryptographic key.

9. The computer program product according to claim 8, wherein the cryptographic algorithm is a homomorphic algorithm, wherein the computer-readable program code portions further comprise executable code portions for:
receiving, from a user associated with the augmented reality device, a request to execute one or more operations on the encrypted data; and
executing the one or more operations on the encrypted data, the one or more operations comprising at least one of an addition, substitution, or deletion of at least a portion of the encrypted data

10. The computer program product according to claim 8, wherein the computer-readable program code portions further comprise executable code portions for establishing a secure handshake connection to the augmented reality device, wherein the cryptographic key is transmitted to the augmented reality device through the secure handshake connection.

11. The computer program product according to claim 8, wherein the intelligent privacy screen is associated with a predefined list of authorized devices, wherein the predefined list of authorized devices comprises the augmented reality device.

12. The computer program product according to claim 8, wherein the set of sensitive data is encrypted using a first encryption key associated with the cryptographic key.

13. The computer program product according to claim 8, wherein the computer-readable program code portions further comprise executable code portions for encrypting a second set of sensitive data using a second encryption key, wherein the cryptographic key is incompatible with the second set of sensitive data.

14. A computer-implemented method for end-to-end electronic data encryption using an intelligent homomorphic encrypted privacy screen, wherein the computer-implemented method comprises:
encrypting, using a cryptographic algorithm, a set of sensitive data to generate encrypted data;
displaying the encrypted data on an intelligent privacy screen;
receiving authentication data from an augmented reality device associated with the intelligent privacy screen;
transmitting a cryptographic key to the augmented reality device, wherein the cryptographic key is a decryption key associated with the encrypted data; and
decrypting, through the augmented reality device, the encrypted data using the cryptographic key.

15. The computer-implemented method according to claim 14, wherein the cryptographic algorithm is a homomorphic algorithm, wherein the computer-implemented method further comprises:
receiving, from a user associated with the augmented reality device, a request to execute one or more operations on the encrypted data; and
executing the one or more operations on the encrypted data, the one or more operations comprising at least one of an addition, substitution, or deletion of at least a portion of the encrypted data

16. The computer-implemented method according to claim 14, wherein the computer-implemented method further comprises establishing a secure handshake connection to the augmented reality device, wherein the cryptographic key is transmitted to the augmented reality device through the secure handshake connection.

17. The computer-implemented method according to claim 14, wherein the intelligent privacy screen is associated with a predefined list of authorized devices, wherein the predefined list of authorized devices comprises the augmented reality device.

18. The computer-implemented method according to claim 14, wherein the set of sensitive data is encrypted using a first encryption key associated with the cryptographic key.

19. The computer-implemented method according to claim 14, wherein the computer-implemented method further comprises encrypting a second set of sensitive data using a second encryption key, wherein the cryptographic key is incompatible with the second set of sensitive data.

20. The computer-implemented method according to claim 14, wherein the augmented reality device is a pair of smart glasses or a headset.
